(19) United States
(12) Patent Application Publication
(10) Pub. No.: US 2010/0106276 A1
(43) Pub. Date: Apr. 29, 2010

(54) METHOD FOR MODELLING OR PRODUCING A DENTURE SUPPLY, MACHINE-READABLE DATA CARRIER, AND COMPUTER

(75) Inventors: Stephan Holzner, Hohenschaftlarn (DE); Gerhard Weber, Purgen (DE)

Correspondence Address: RISSMAN HENDRICKS & OLIVERIO, LLP, 100 Cambridge Street, Suite 2101, BOSTON, MA, 02114, US

(73) Assignee: etkon Centrum fur dentale CAD/CAM-Technologie AG, Grafelfing (DE)

(21) Appl. No.: 12/522,999

(22) PCT Filed: Jan. 9, 2008
(86) PCT No.: PCT/EP2008/000123

§ 371 Date: Dec. 3, 2009

(30) Foreign Application Priority Data
Jan. 15, 2007 (DE) 10 2007 002 143.9

(51) Int. Cl. G06F 17/50

(52) U.S. Cl. 700/98; 703/1; 700/119

(57) ABSTRACT

The invention relates to a method of modelling a denture supply, such as a bridge construction, a crown, a cap, a set of artificial teeth or the like, said method comprising the following steps: creating or loading a first data record recording the shape of an initial situation before any treatment, such as the extraction or grinding of one or of a plurality of teeth, and creating or loading a second data record recording the shape of a post-treatment situation, and using the first and second data records for modelling the denture supply. The invention also relates to associated computer-readable data carriers and a computer.

### FIELD OF THE INVENTION

The present invention relates to a method for modelling or producing a denture supply, and to a computer-readable data carrier, and a computer.

### BACKGROUND

It is known to model various denture parts, such as crowns or bridges, with a CAD method. In so doing, a data record can be resorted to, which represents the shape of a tooth area, a remaining tooth area, a gum area or the like, which is to be connected to the denture part.

Upon modelling the denture supply, attention must be paid to a sufficient stability of the denture supply, since the forces acting on the denture supply during chewing are normally very large.

In addition, a denture supply normally aims at guaranteeing the best possible natural look. For this purpose, e.g. veneers of bridges are known, which exhibit a tooth-coloured hue.

It is the object of the present invention to provide an improved method for modelling a denture supply, an appropriate computer-readable data carrier as well as a computer, and to provide in this way also an improved denture supply.

In accordance with one embodiment of the invention, a method of modeling a denture supply is provided which includes the following steps:
providing a first data record recording the shape of an initial situation before any treatment, such as the extraction or grinding of one or of a plurality of teeth,
providing a second data record recording the shape of a post-treatment situation, and
using the first and second data records for modeling the denture supply.

In accordance with one embodiment of the invention, a computer-readable data carrier is provided with instructions which will cause a computer to execute the above method.

In accordance with another embodiment of the invention, a computer is provided with a computer-readable data carrier as described above.

Advantageous embodiments are disclosed in the following description and claims.

When executing the method, a data record is taken into account, which records the shape of the initial situation of the patient. For fitting a denture supply, one or more treatments will normally be executed in the course of which e.g. teeth or implant posts are ground or teeth are extracted. The grinding of teeth or implant posts serves to provide room and appropriate supporting points for a denture supply.

Prior to executing such grinding or tooth extraction or other treatments, the shape of an initial situation will be recorded in the form of a data record, so that said shape of the initial situation can then be used for modelling the denture supply.

In this way denture supplies can be created, which are as similar as possible to the original initial situation so that the original look before the treatment and the insertion of the denture supply can be restored.

The two data records represent the shape preferably in three dimensions, i.e. a three-dimensional image of the initial situation and/or of the situation after the treatment is provided. Normally, e.g. the surface data of a three-dimensional representation can be stored in the data records.

The method is preferably a CAD (computer-aided-design) method.

In addition, a second data record is used, which records the situation after the treatment, since this data record can be used for modelling a respective denture supply or part of a denture supply. The inner shape of a crown, a bridge, a primary crown, a cap, a prosthesis, an inlay, an onlay, an overlay or of similar denture supplies can be specified e.g. by the shape of a ground tooth.

The first data record, which records the shape of the initial situation, can e.g. be used for being displayed during the modelling of the denture supply. It follows that the data record can be used by an operator of the respective software as a guideline indicating where and how a denture supply has to be formed.

The display preferably takes place in superposition with the second data record (or with a detail thereof allowing an enlarged representation), which represents the actual situation of the patient.

In denture supply modelling processes an automatic selection of predetermined shape data records can be carried out by means of a software. It is thus possible to select for a missing tooth e.g. an automatic suggestion for a suitable abutment, an artificial tooth or the like. If a plurality of predetermined shape data records should be available for a specific tooth position, a shape data record can be selected, which, with due regard to the first data record, allows a denture supply that is as similar as possible to the initial situation.

In addition to the criterion of similarity with the initial situation, also a further criterion can be taken into account, viz. that of an ideal situation, i.e. a denture supply that creates for a given patient an ideal shape from an aesthetic point of view. A simulation of such an ideal denture supply or the simulation of some other denture supply can be displayed, in addition to or alternatively to the basic data record, in a semitransparent manner and/or such that it can be made visible or hidden. This simulation of an (ideal) denture supply can be created with due regard to jaw dimensions, tooth dimensions, stored dimensions and/or shapes and/or models corresponding to an ideal denture supply. Preferably, it is automatically created by the software, but it may also be created and/or modified by an operator of the software. A denture supply which is ideal from an aesthetic point of view may e.g. be a denture supply whose selectable dimensions or shapes correspond to average values (of a certain amount of human beings), since these shapes are normally regarded as being aesthetically appealing.

The criteria of similarity with the initial situation and the ideal denture supply can also be used for selecting shape data records with variable weightings. This allows an operator to easily create a denture supply which resembles the original look on the one hand and which represents an aesthetic improvement on the other, since it approaches an ideal denture supply at least to a certain extent.

As regards the selection of shape data records and the modification of such shape data records, it will additionally be advantageous when an external person, such as the patient or a dentist, is given the opportunity of viewing various modellings of the denture supply through data remote transmission. For example, various models corresponding to an initial situation and/or an ideal denture supply to a higher or lesser degree can be created, so that the patient or the dentist (i.e. quite generally an arbitrary external person) can select one of these models.

Another possible criterion for selecting a suggestion is the stability of the denture supply. This stability can be calculated or simulated with a finite element method. Also the stability can be taken into account as a weightable criterion. It is, however, also possible to take the stability only into account insofar as a predetermined minimum stability has to be achieved.

Likewise, a modification of automatically selected shape data records or, if only one shape data record should be relevant in view of the tooth position, a modification of said one shape data record can be executed automatically so as to optimize the respective shape data record e.g. with respect to size, length, width, height or the like. Also such modifications can be carried out with due regard to the first data record and/or a simulation of an ideal denture supply and/or stability aspects.

Automatic modifications can be carried out with due regard to stored empirical values indicating e.g. how much space must be kept free for a tooth veneer.

A first data record can be created by scanning the initial situation at the patient or at a model of said initial situation. For example, scanners are imaginable, which scan the initial situation directly in the patient's oral cavity, but scanners scanning a model thereof (e.g. a plaster model) are imaginable as well. To this end, an optical scanner or a mechanical probe can be provided.

Also the second data record can be acquired directly in the patient's mouth or at a model thereof.

Irrespectively of when, where and how the data records are created, the method may also be executed by simply loading such data records. The scanning may, for example, be executed at the dentists or at the dental technician's office, whereas the method is executed at a dental technician's office or at a denture supply manufacturer's office, such as a milling centre or some other denture supply production centre.

The scanner used may be a tomograph, such as a computer tomograph (also CT scanner), an X-ray scanner, an NMR scanner, an optical scanner or some other scanner or a mechanical probe.

The various data records can be transmitted by data remote transmission. This allows an execution of various steps at various sites.

The denture supply can be produced by means of a rapid prototyping process and/or a CAM process. Rapid prototyping processes are primary forming methods by means of which the workpiece is built preferably in layers from shapeless or shape-neutral materials by utilizing physical and/or chemical effects. Such primary forming methods comprise e.g. stereolithography, selective laser sintering, laser generation, fused deposition modelling, laminated object modelling, 3D printing, contour crafting, multijet modelling or a polyjet process. CAM processes comprise e.g. the rapid prototyping process as well as milling.

According to a particularly advantageous embodiment of the method, also the colour situation of the initial situation is recorded. For this purpose, a scanner can be provided, which records the colour of teeth and/or of the gums or the like. The colour may be recorded for each individual tooth, but it is also possible to record the situation as a whole. Since also colour gradients will normally occur in teeth or in the gums, such colour gradients can preferably be recorded as well. This means that the colour situation can be recoded in a spatially resolved manner.

Such a recorded colour situation can e.g. be displayed together with the first data record. This is done by displaying a surface, which is representative of the first data record, in a colour corresponding to the colour situation.

The colour situation can be taken into account when the denture supply is being modelled. For example, a desired colour and/or a colour design (e.g. with a colour gradient) of the denture supply can be specified and stored already during the modelling process.

Accordingly, it will then also be advantageous to take into account the colour situation when the denture supply is being produced, i.e. it will be of advantage when the information that was generated with respect to the colour during the modelling process is taken into account upon producing the denture supply.

A data record which is representative of the colour situation of the initial situation can also be transmitted through data remote transmission so that various method steps can be executed at various sites by various persons. For example, a modelled denture supply can be produced in a denture supply production centre (e.g. by producing a bridge construction) and the denture supply produced can be sent to a dental technician, to whom also the colour situation will be sent, so that he will be able to mask e.g. the bridge with veneers having colours that are as similar as possible to the initial situation.

### BRIEF DESCRIPTION OF THE DRAWINGS

Preferred embodiments of the present invention will be explained on the basis of the attached figures, in which:

FIG. 1 shows a schematic representation of an initial situation and of a post-treatment situation,

FIG. 2 shows a schematic representation of a computer,

FIG. 3 shows a schematic representation of data records and denture supplies,

FIG. 4 shows various sectional views of an initial situation,

FIG. 5 shows various sectional views of a situation after a treatment,

FIG. 6 shows a schematic representation of two data records in superposition.

### DETAILED DESCRIPTION

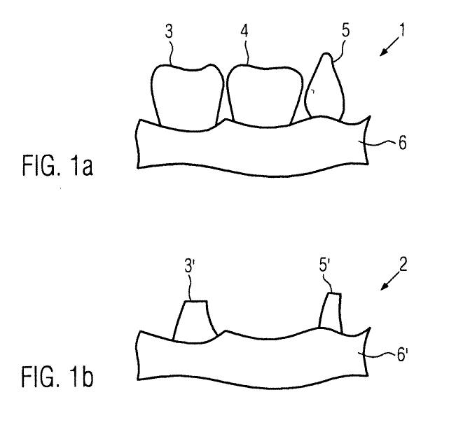

FIG. 1a shows a schematic representation of an initial situation. In a gum area 6, three teeth 3, 4, 5 can be seen. This initial situation 1 corresponds to the situation existing before the denture supply treatment has begun.

FIG. 1b shows the situation after such treatment. Tooth 4 has been extracted and teeth 3 and 5 have been ground. What remains are tooth stumps 3′, 5′ as well as a modified gum area 6′.

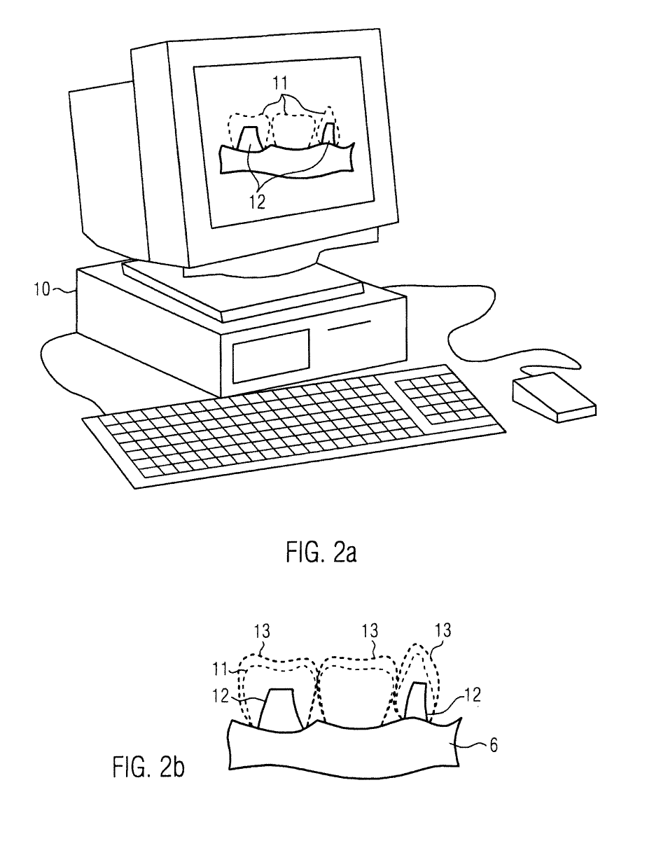

Data records, which are shown in FIG. 2a on a computer 10 and in FIG. 2b separately, exist with respect to the initial situation 1 as well as with respect to the post-treatment situation 2. Data record 11 represents the initial situation and data record 12 represents the post-treatment situation, i.e. the situation in which the denture supply can be inserted.

As can be seen in FIG. 2, the two data records are superimposed on one another in the representation shown. Although the representation on the screen in FIG. 2 is shown only schematically, like a sectional view, said representation is normally shown in a three-dimensional form on the screen. It follows that, when a denture supply is being modelled, not only the situation represented by the data record 12 but also the initial situation (cf. data record 11) is optically discernible without any difficulty, so that the initial situation can be taken into account during modelling of the denture supply. The initial situation can be shown in a semitransparent manner and/or it can be made visible or hidden so that the (normally) underlying “actual situation” 12 will become visible.

In FIG. 2b a simulation of an ideal denture supply 13 is additionally made visible. The teeth here e.g. do not have any gaps between them. In addition, the upper edge of the teeth is more uniform in comparison with that of the actual situation. These are general examples for characteristics of an ideal denture supply.

The shape of a software-suggested denture supply can e.g. lie between the two lines of the data record 12 and of the simulation 13 in the sectional view according to FIG. 2b. Depending on the weighting of the ideal denture supply and the initial situation, the suggestion will be more similar either to the ideal denture supply or to the initial situation.

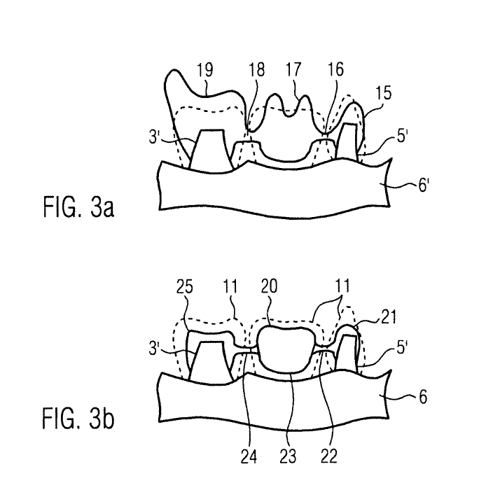

FIG. 3a shows an example for a possible denture supply. This denture supply consists here of a bridge with two bridge parts 15, 19, two connectors 16, 18 and a pontic 17. Such bridge constructions can be produced from very hard materials, such as ceramic, titanium or the like. Subsequently, they can be masked with a veneer.

The solution shown in FIG. 3a is, however, unsatisfactory insofar as the bridge parts 15, 19 and the pontic 17 clearly extend beyond the initial situation 1 (cf. data record 11) so that it is impossible to restore the original look with such a denture supply.

FIG. 3b, however, shows a solution in the case of which a bridge has been established by making use of two bridge parts 21, 25, two connectors 22, 24 as well as a pontic 23. The whole bridge (with the exception of the connectors 22, 24) is located within the outer boundary of the data record 11, so that the bridge can be designed with suitable veneers such that it will reproduce teeth which are very similar to those of the initial situation 1.

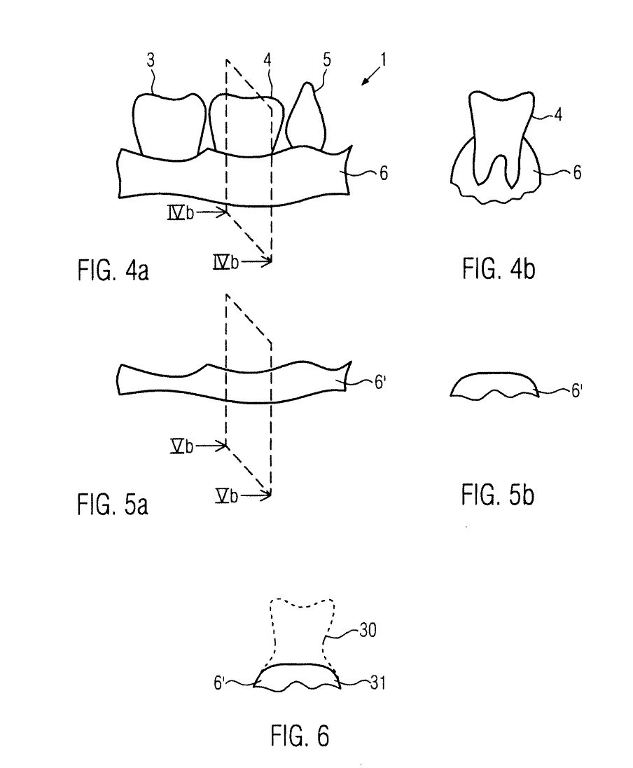

Only the connectors 22, 24 are located outside of the shape specified by the data record 11, but this is unavoidable, since the respective teeth 3, 4, 5 are separated by small gaps. In the case of abutting teeth, the connectors are preferably provided in the area in which the teeth abut on one another.

Whereas in FIG. 3 a bridge has been discussed as an example for a denture supply, FIGS. 4 to 6 show a set of artificial teeth. The invention explained can, however, be used for any kind of denture supply, such as crowns, bridges, prostheses, inlays, onlays, overlays, caps, a set of artificial teeth, implants, abutments, primary crowns, secondary or tertiary constructions or the like.

In FIG. 4a, the initial situation 1 is shown with an indication concerning the position of the sectional view shown in FIG. 4b, where the gums 6 with the molar 4 are shown.

The post-treatment situation is shown in FIGS. 5a and 5b. All the teeth 3, 4, 5 have here been extracted so that the gums 6 will slightly collapse; these gums are here designated by reference numeral 6′.

In FIG. 6 a data record for the gums 6′ is shown (solid line) together with a data record 30, which is indicated by a broken line and which represents the initial situation (cf. FIG. 4). The data record 31, which represents the shape of the gums 6′, can be used for specifying the lower shape of a set of artificial teeth (false teeth), whereas the data record 30 can be used for modelling both the artificial gums as well as an artificial tooth.

Upon modelling a denture supply, such as the bridge according to FIG. 3, the external colour of the desired denture supply can be modelled as well. This information can be sent additionally to a dental technician who will make a veneer for the bridge.

Also in the case of a method for modelling and producing a set of artificial teeth (cf. FIGS. 4 to 6) it will be advantageous to record the color information of the initial situation (cf. FIG. 4) in the form of a respective data record. When such a set of artificial teeth is produced by an automated production process (e.g. a rapid prototyping process or a milling process), it will then also be possible to accomplish an appropriate colour or to apply such a colour subsequently.

It follows that, by recording the colour situation of the initial situation, sets of artificial teeth and denture supplies in general can be produced, which are very similar to the initial situation also with respect to the respective colour.

A special example for the course of action employed for producing a denture supply will be explained in the following. The example concerns exemplarily and concretely the production of a set of artificial teeth. These steps may, however, also be carried out for all other denture supplies in a corresponding manner.

A dental impression of a patient's existing set of teeth (cf. FIG. 4) is made and is then used for making a plaster model of said set of teeth. The model is optically scanned and the resultant data record (reference numeral 30) is stored. Subsequently, the existing teeth are extracted and/or ground (cf. FIG. 5). An impression is also made of this situation, and the corresponding plaster model is scanned (data record 31). Said data record 31 is used for determining the shape of the lower surface (the surface facing the jaw) of the set of artificial teeth, said shape corresponding to the shape of the data record 31 so as to guarantee an optimum fit.

A software makes automatically generated suggestions for the lateral surfaces and the top surfaces (cf. e.g. data record 30), which can be adopted unchanged or which can still be modified. The automatically generated suggestion can take into account the actual situation, the initial situation (cf. FIG. 4a) and/or a simulated ideal situation, optionally with different weightings. For establishing the automatic suggestion, predetermined shape data records are resorted to. It is also possible to display the initial situation, instead of the automatic suggestion, and to execute the modelling of the desired denture supply on a computer. The initial situation shown serves here as a guideline for the modelling.

By means of the software, a digital model of the denture supply is established, which is then sent, e.g. through remote data transmission, to a CAM (computer-aided manufacturing) machine that will produce the denture supply.

1. A method of modelling a denture supply, comprising the following steps:
providing a first data record recording the shape of an initial situation before any treatment, such as the extraction or grinding of one or of a plurality of teeth,
providing a second data record recording the shape of a post-treatment situation, and
using the first and second data records for modelling the denture supply.

2. A method according to claim 1, wherein the data of the second data record are used for specifying the shape of a part of the denture supply.

3. A method according to claim 1, wherein the first data record displayed during the modelling of the denture supply.

4. A method according to claim 1, wherein the first data record is used for automatically selecting and/or automatically modifying one or more predetermined shape data records, for modelling the denture supply.

5. A method according to claim 4, wherein the automatic selection of one or more predetermined shape data records is determined with regard to a criterion concerning the similarity of the denture supply with the initial situation and/or a simulated situation, with an automatically predetermined or an adjustable weighting, for said automatic selection.

6. A method according to claim 1, wherein a simulation of a denture supply is created and displayed during the modelling of the denture supply.

7. A method according to claim 1, wherein the first data record is created by scanning the initial situation at the patient or at a model of the patient.

8. A method according to claim 1, wherein the second data record is created by scanning executed at the patient or at a model of the patient.

9. A method according to claim 7, wherein the scanning is executed with a CT scanner, an X-ray scanner, an NMR scanner, an optical scanner or a mechanical probe.

10. A method according to claim 1, wherein the first and/or the second data record is/are transmitted by data remote transmission from one computer to another computer.

11. A method of producing a denture supply comprising the steps of modelling the denture supply according to claim 1, and producing said denture supply by a rapid prototyping process and/or a CAM process.

12. A method according to claim 1, wherein the first or an additional data record records the colour situation of the initial situation.

13. A method according to claim 12, wherein the colour situation is displayed together with the first data record.

14. A method according to claim 12, wherein the colour situation is taken into account when the denture supply is being modelled.

15. A method according to claim 11 wherein the first or an additional data record records the colour situation of the initial situation and the colour situation is taken into account when the denture supply is being produced.

16. A method according to claim 12, wherein the data record is transmitted, together with the colour situation, through data remote transmission.

17. A computer-readable data carrier with instructions which will cause a computer to execute a method according to claim 1.

18. A computer with a computer-readable data carrier according to claim 17.

19. A method according to claim 1, wherein the denture supply is one or more of a bridge construction, a crown, a cap, a set of artificial teeth, a prosthesis, an inlay, an onlay, an overlay, an implant, an abutment, a primary crown, a secondary construction, or a tertiary construction.

20. A method according to claim 3, wherein the first data record is displayed in superposition with at least part of second data record.

21. A method according to claim 4, wherein the predetermined shape data records are one or more of predetermined pontics, connectors, links, crowns, primary crowns, secondary crowns, and artificial teeth.

22. A method according to claim 5, wherein the initial situation and/or simulated situation is an ideal situation.

23. A method according to claim 5, wherein the automatic selection is determined with respect to both the initial situation and the simulated situation.

24. A method according to claim 6, wherein the simulation is an ideal denture supply.

25. A method according to claim 6, wherein the simulation is displayed in a semitransparent manner.

26. A method according to claim 6, wherein the displayed simulation can be made visible or hidden.
